(19) United States
(12) Patent Application Publication
(10) Pub. No.: US 2014/0067919 A1
(43) Pub. Date: Mar. 6, 2014

(54) STORAGE MEDIUM, METHOD AND DEVICE

(71) Applicant: FUJITSU LIMITED, Kawasaki-shi (JP)

(72) Inventors: Takatoshi TADA, Numazu (JP); Kouichi NAKAMURA, Suntougun (JP); Toshiyuki WATANABE, Numazu (JP)

(73) Assignee: FUJITSU LIMITED, Kawasaki-shi (JP)

(21) Appl. No.: 13/971,048

(22) Filed: Aug. 20, 2013

(30) Foreign Application Priority Data
Aug. 29, 2012 (JP) 2012-189211

(51) Int. Cl. H04L 29/06

(52) U.S. Cl. CPC H04L 29/06047
USPC 709/203

(57) ABSTRACT

A method includes: specifying a current damage number of a server; storing the current damage number, generations of the information resources and generation information before damage in the server in association with information resources when the information resources are stored in the server; and providing the client with the information resources, and the damage number, the generations and the generation information before damage in association with the information resources. The damage number, the generations and the generation information before damage provided to the client are at least used to restore the server from any damage, and the generation information before damage includes the damage number and the generation of an original information resource which serves as the basis of update of the information resource, the damage number of the original information resource being smaller than the damage number of the information resources.

### CROSS-REFERENCE TO RELATED APPLICATIONS

This application is based upon and claims the benefit of priority of the prior Japanese Patent Application No. 2012-189211 filed on Aug. 29, 2012, the entire contents of which are incorporated herein by reference.

### FIELD

The embodiments discussed herein are related to a storage medium storing an information resource management program, method and device for managing information resources.

### BACKGROUND

With the recent advance in technologies in, for example, network systems and client-server systems, a technology is widely used in which the server systems centrally manage the information resources along with generation information. For example, a number of information resources updated by a plurality of clients may be managed by the servers along with the relevant generation information in a unified manner. Examples of information resources managed by generation may include the source programs for computer program development and various types of documents. However, information resources targeted by the present disclosure are not limited to these examples.

For a system in which a server manages information resources intensively, there may be some cases where the information resources managed by the server are lost due to the damages to the server such as, for example, a software failure and a hardware failure. A computer-based system requires a measure against such losses of information resources. In this case, the method of restoring the lost information resource is a subject of a challengeable task. Typical measures against these problems may include a data backup and a hardware resource redundancy.

However, such conventional measures cannot exclude a situation of a total loss of the data backup and the redundant hardware resources. If there remain information resources in a client under such a situation, there may be a case where the remaining information resources are collected to restore the lost information resources in the damaged server.

However, information resources possessed by a client may include information resources of different generations. Further, even if the information resources have the same generation, it has been difficult to understand completely whether which of the generation is used for the modification of the information resources. For example, there may be a case where the damage number of the server (e.g., the history on the number of damages/restorations in the information resources) is different in the same generations. Accordingly, even if the information resources collected by the client are simply stored in the server in the order of generation, there may be a case where the consistency for the histories of the information resources (e.g., the damage number of the server) may not be guaranteed. This imposes a limitation on a mechanical restoration process of collecting information resources from the client. Therefore, in many cases, there is a need for an operator to perform a manual restoration process. In addition, when information resources are found in the client after the operation is resumed upon completion of the restoration, since the manual restoration process for the information resources has been already ended, it has been very difficult to determine whether or not the found information resources can be simply stored in the server.

There has been a technique for managing the properties and their generations using a generation management library having a real property region storing properties, a security information region storing security information on the properties, and information on an update order of the properties.

In addition, when a page in the data file is damaged by a system failure, the update history information related to the page and not reflected in the data file is collected from all the journal files. There has also been a technique for destroying update history information after the update history information is missing using a page restoring means for performing a restoring operation in a time sequential order controlled by an order control means, thereby preventing the destroyed update history information from being reflected in the data file.

Japanese Laid-open Patent Publication Nos. 8-16440 and 10-228404 are known as examples of related art.

### SUMMARY

According to an aspect of the invention, there is provided a computer-readable storage medium storing a computer executable program that, when executed, causes a server to manage information resources and generations of the information resources managed by a client and causes the server to execute a process includes: specifying a current damage number of the server; storing the current damage number, the generations and generation information before damage in the server in association with the information resources when the information resources are stored in the server; and providing the client with the information resources, the damage number, the generations and the generation information before damage in association with the information resources, wherein the damage number, the generations and the generation information before damage provided to the client are at least used to restore the server from any damage, and wherein the generation information before damage includes the damage number and the generation of an original information resource which serves as the basis of update of the information resource, the damage number of the original information resource being smaller than the damage number of the information resources.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIGS. 1A, 1B and 1C are views illustrating an outline of a generation management of a source program according to an embodiment.

FIGS. 2A and 2B are views illustrating a process of merging and storing the sources maintained at a client in a server after the server is damaged according to an embodiment.

FIGS. 3A and 3B are views illustrating a process of intactly storing the sources maintained at a client in a server after the server is damaged according to an embodiment.

FIG. 4 is a schematic flow chart of a process of restoring a server using a source remaining in a client.

FIG. 5 is a flow chart illustrating the details of the process in the server when an object source maintained at a client is not updated.

FIG. 6 is a flow chart illustrating the details of the process in the server when an object source maintained at a client is updated.

FIG. 7 is a functional block diagram of an embodiment.

FIG. 8 is a view illustrating an exemplary hardware configuration according to an embodiment.

FIG. 9 is a view illustrating a source management in a server according to an embodiment.

### DESCRIPTION OF EMBODIMENTS

An aspect of the present disclosure is to build an environment in which the information resources of the server can be readily restored using the information resources remaining in a client when the server is damaged.

Hereinafter, embodiments will be described with reference to the accompanying drawings. It should be noted that the following embodiments are provided for the purpose of understandings of the disclosure but are not intended to limit the scope of the disclosure. It is also noted that the following embodiments are not exclusive with each other. Therefore, it should be noted that various elements of different embodiments are intended to be combined unless contradictory. In the methods and programs of the disclosure defined in the claims, process orders may be exchanged or a plurality of processes may be performed simultaneously, unless contradictory. It should be understood that these embodiments are encompassed in the technical scope of the disclosure defined in the claims.

It should be also understood that the present disclosure includes the following embodiments implemented by executing program codes read by a computer as well as embodiments implemented by executing an actual partial or entire process by other programs such as an operating system (OS) running on a computer based on the program codes.

In the specification, embodiments of managing source programs and their generations for computer software in a server are mainly illustrated. In the specification, the source programs may be abbreviated as “sources.”

The present disclosure is not limited to the management of sources and their generations. It should be noted that the present disclosure is applicable to all information resources managed at least by generations including typical documents, design documents, and definitions. Accordingly, it should be understood that the embodiments illustrated and described in the detailed description and the drawings are provided to make the present disclosure well understood to those skilled in the art but is not intended to limit the scope of the disclosure.

### Embodiments

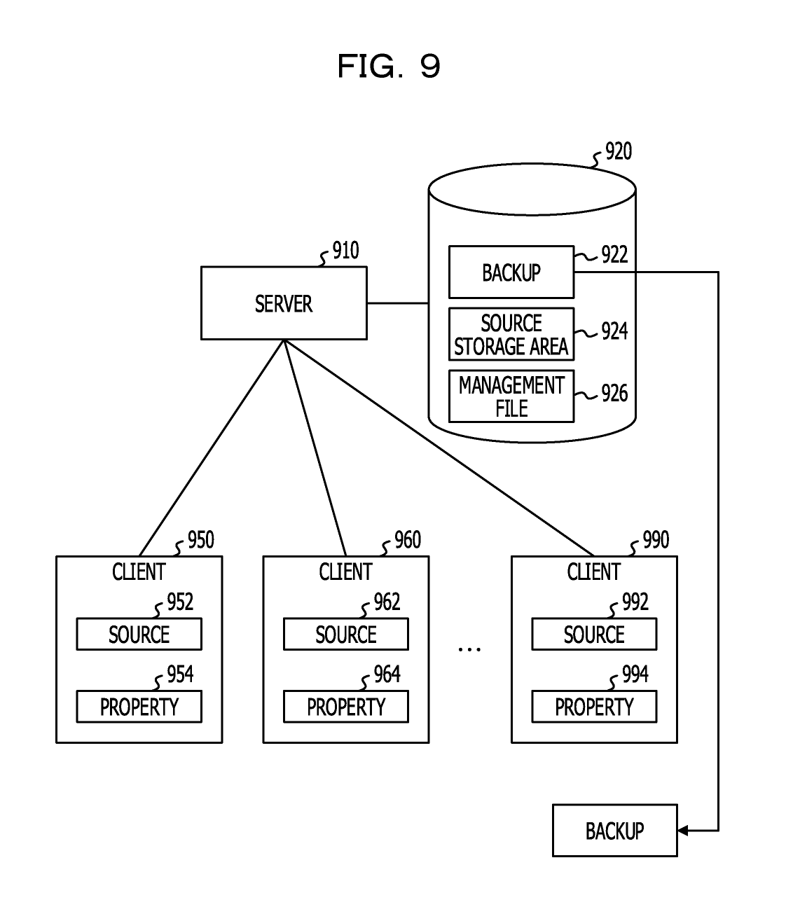

FIG. 9 is a view illustrating the source management in a server according to an embodiment. A client 950 uses a source 962 and the client 950 may update the source 962 as necessary. In the client 950, for example, information on the generations related to the source 952 may be managed by a property 954. The client 950 may upload the source 952 into a server 910 as necessary. The server 910 may store the uploaded source 952 in a source storage area 924 of a storage 920. If the source stored in the source storage area 924 is updated by the client 950, the server 910 attaches a new generation to the updated source and stores the updated source in a management file 926. In addition, the management information such as, for example, the attached generation information may be provided to the client 950. This allows the generation information attached by the server to be associated with the updated source 952 maintained at the client 950, and the generation information may be stored in the property 954.

In FIG. 9, a client 960 may download and use a source stored in the source storage area 924 of the server 910. The downloaded source 962 and the management information such as the generation related to the source 962 may be downloaded from the server. The downloaded management information such as the generation may be stored in the property 964 associated with the source 962 in the client 960. The client 960 may use the source 962 with or without updating as necessary. A source 992 and related property 994 may be stored in a client 990 to be used.

In this manner, the server 910 stores and manages the sources maintained at the clients 950-990 in the storage 920. In addition, a source is provided to each client 950-990 at a request from each client. If a client 950, 960, . . . , 990 updates a source, the server 910 stores the updated source in the source storage area 924 along with the management information on the new generation attached to the updated source, and then updates the management file 926. In addition, the attached management information on the new generation is offered from the server 910 to the clients 950-990, and the sources and management information maintained at the server may be matched to sources and their relevant properties maintained at the clients 950-990.

If the server 910 and/or the storage 920 are damaged (e.g., a hardware failure and/or a software failure) and the information in the source storage area 924 and/or the management file 926 is partially or completely lost, a restoring process starts. A typical process is performed by restoring the source storage area 924 and the management file 926 from a backup 922. The backup 922 may be stored as a copy backup 923 at a geographically remote place.

In rare cases, the information of both of the backup 922 and the stored copy backup 923 may be lost. In these cases, the backup/restore process described above may not be performed due to the unavailability of the backup 922 (and the copy backup 923). Fortunately, however, there may be some cases where each of the clients 950-990 maintains its respective sources 952, -992 and corresponding properties 954-994. This can provide a possibility of restoring the source storage area 924 and its management file 926 managed by the server 910 by collecting necessary information from the clients 950-990.

In the following embodiments, descriptions will be made regarding a case where the source storage area 924 and its management file 926 managed by the server 910 are restored by collecting necessary information from the clients 950-990.

In the specification, an information resource serving as a basis for update of other information resources is called an original information resource.

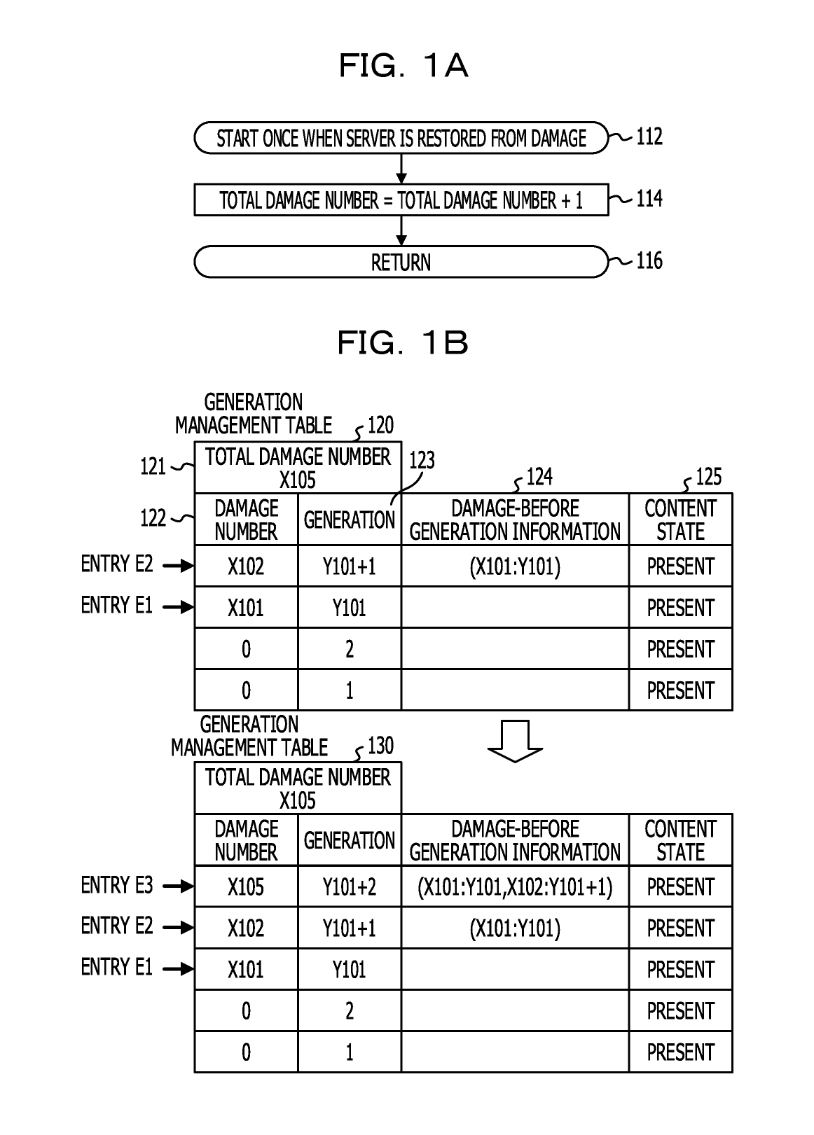

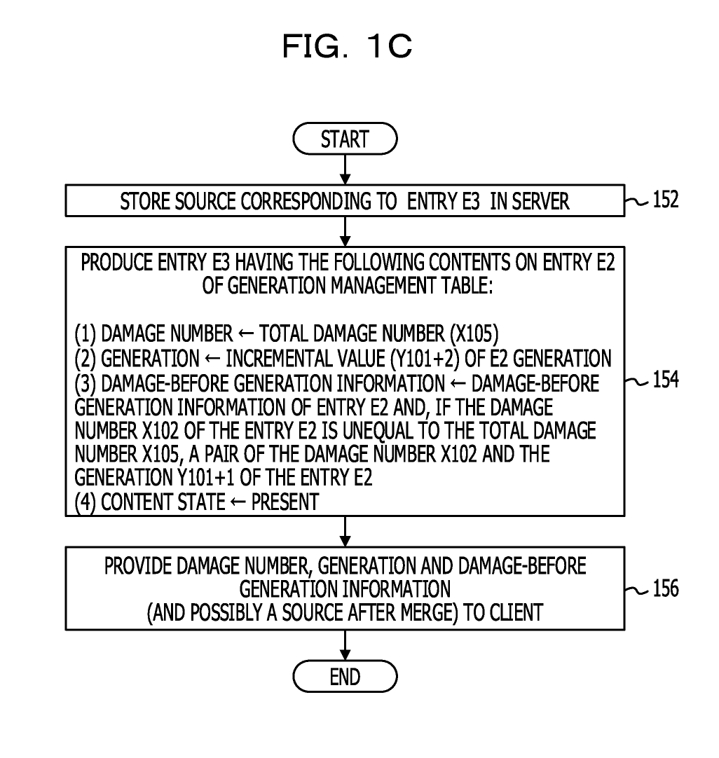

FIGS. 1A, 1B and 1C are views illustrating an outline of the generation management of a source program according to an embodiment.

FIG. 1A is a flow diagram illustrating an increment in the total damage number when the server 910 managing the sources and the generations of the sources is damaged and is then restored from the damage. When the server 910 starts to be operated, the server 910 may be damaged with a certain probability (loss of various data) and is restored thereafter (restoration of various data). The process of FIG. 1A corresponds to a process by the server to store the damage number until the present in a “total damage number,” when the server is restored from the damage.

At step 112, the process is started once when the server is restored from the damage.

At step 114, the total damage number managed by the server is incremented.

At step 116, the process returns.

The total damage number may be updated in an incremental fashion. In addition, a case where the information on the total damage number is lost may be envisaged. In this case, the server may prompt an operator to set the total damage number. If the operator does not know the total damage number occurred before a specific damage, the operator may set the total damage number to be even larger than the damage occurred before the specific damage. As an alternative to the total damage number, an ever-incrementing number such as, for example, the current date, hour, minute and second may be used. In this manner, the total damage number may use a larger number than the total damage number occurred before a specific damage to distinguish the temporal order between the total damage number occurred before the specific damage and the total damage number occurred after the specific damage.

FIG. 1B is a view illustrating an example of the generation management in the server. For example, the total damage number 121 is stored and its value is X105. A generation management table 120 stores the management information of a plurality of sources stored in the server. For example, in an entry E1, X101 is stored as the damage number 122 of the server when the source is stored in the server, Y101 is stored as the generation 123, and “present” is stored in content state 125 as the generation information before damage 124. Details of the generation information before damage 124 will be described later in the following description in the entry update. If the content state 125 is “present,” it is understood that a source of a corresponding entry is stored in the server. Otherwise, if the content state 125 is “empty,” it is understood that the source of a corresponding entry is not stored in the server.

A generation management table 130 illustrates a state where the server stores a new source, and an entry E3 corresponding to the new source is added. X105 is stored in the damage number field of the entry E3 which is the same value as the total damage number. In this manner, when the new entry E3 is generated, X105 corresponding to the total damage number of the current server may be intactly stored in the field of the total damage number. Y101+2 is stored in the generation field of the entry E3 which corresponds to an incremental value of Y101+1 stored in the generation field of an entry E2. In this manner, the generation field of a new entry may store an incremental value of the generation of a previous entry. In the field of the generation information before the damage of the entry E3, a pair of damage number X102 of the entry E3 and it generation Y101+1 (X102:Y101+1) is added in addition to the generation information before damage of the previous entry E2 (X101:Y101). In the field of the generation information before the damage, the generation information before the damage of the immediately previous entry is copied intactly and new information is added according to the following rule. That is, when the damage number X102 of the immediately previous entry E2 is different from the total damage number X105, a pair of the damage number X102 of the Entry 2 and the generation Y101+1 is added. When the damage number X102 of the immediately previous entry E2 equals to the total damage number X105, nothing is added. For the generation management table 130, since X102 is different from X105, the content of the entry E3 has (X101:Y101, X102:Y101+1). When X102 equals to X105, the generation information before damage of the entry E3 has (X101:Y101) (not illustrated).

In this manner, the generation information before damage of the previous generation is copied intactly to the newly generated generation information before damage. When the damage number of the entry of the previous generation is different from the total damage number, a pair of the damage number and the generation of the entry of the previous generation is added to the newly generated generation information before damage.

In the above description, the previous generation is assumed to be E2 which is immediately before the newly generated generation E3. A case where a source causing the update of the entry E3 is a source corresponding to the entry E1 may be envisaged. In this case, the source of the entry E3 may not reflect the update content included in the entry E2. Accordingly, in order to reflect the update content of the entry E2 when the source of the entry E3 is stored in the server, the update content of the source of the entry E2 may be merged with the source of the entry E3 to be stored in the server. Such a merging process may be automatically performed by the server by understanding the update content. If it is discovered in the merging process that merged contents are in competition, an operator may be prompted to instruct (and cope with) the merging process. There has been proposed various merging methods. The detailed description of the merging process is omitted for the purpose of clarification and brevity of the description of the disclosure.

FIG. 1C is a flow chart of a process of storing a new updated source in the server.

At step 152, a source corresponding to the entry E3 is stored in the server. In addition, if a merging process is required, the source may be stored after performing the merging process.

At step 154, a series of processes is performed to produce the “entry E3” having the following contents on the “entry E2” of a generation management table. Specifically,

(1) The total damage number (X105) is stored in the field of damage number of the entry E3.

(2) An incremental value (Y101+2) of the generation of the entry E2 is stored in the field of the generation of the entry E3.

(3) The generation information before damage of the entry E2 is copied to the generation information before damage of the entry E3. If the damage number X102 of the entry E2 is different from the total damage number X105, a pair of the damage number X102 and the generation Y101+1 of the entry E2 is stored in addition to the copied generation information before damage.

(4) “Present” is stored in the field of the content state of the entry E3.

At step 156, the damage number, generation and the generation information before damage may be provided to the client. In addition, if the merging process is performed for a source, the merged source may be provided to the client. In this step, the same management information for the same source is maintained in the server and the client.

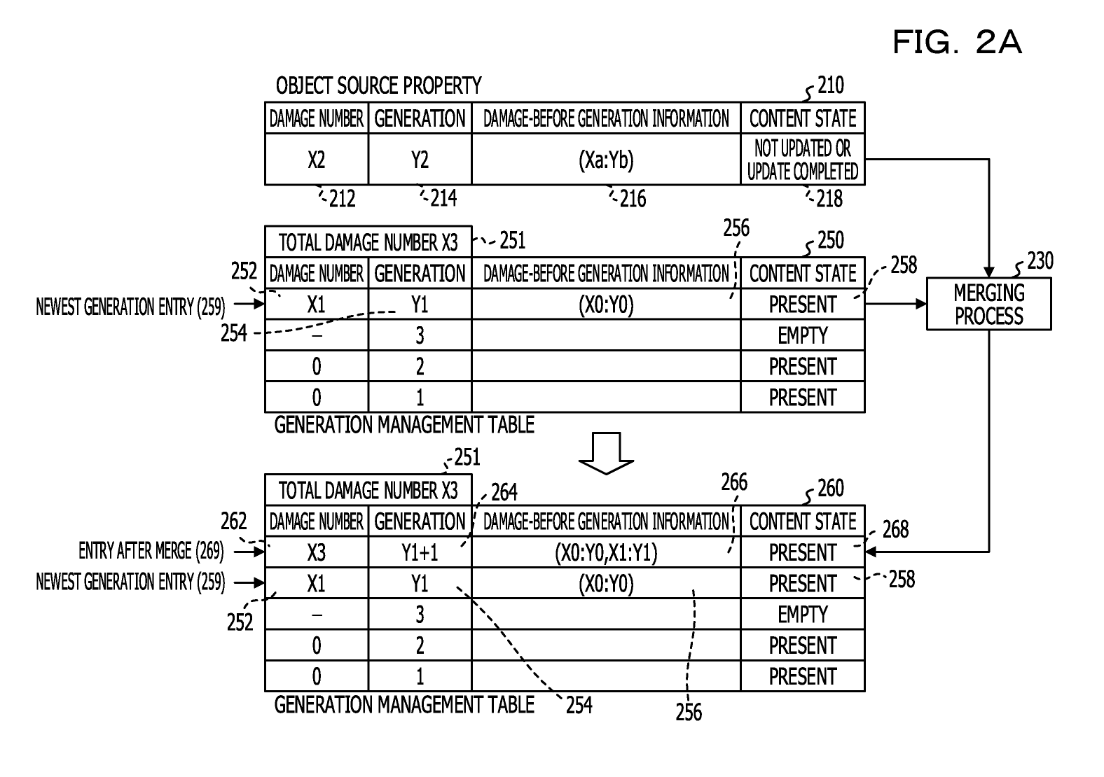

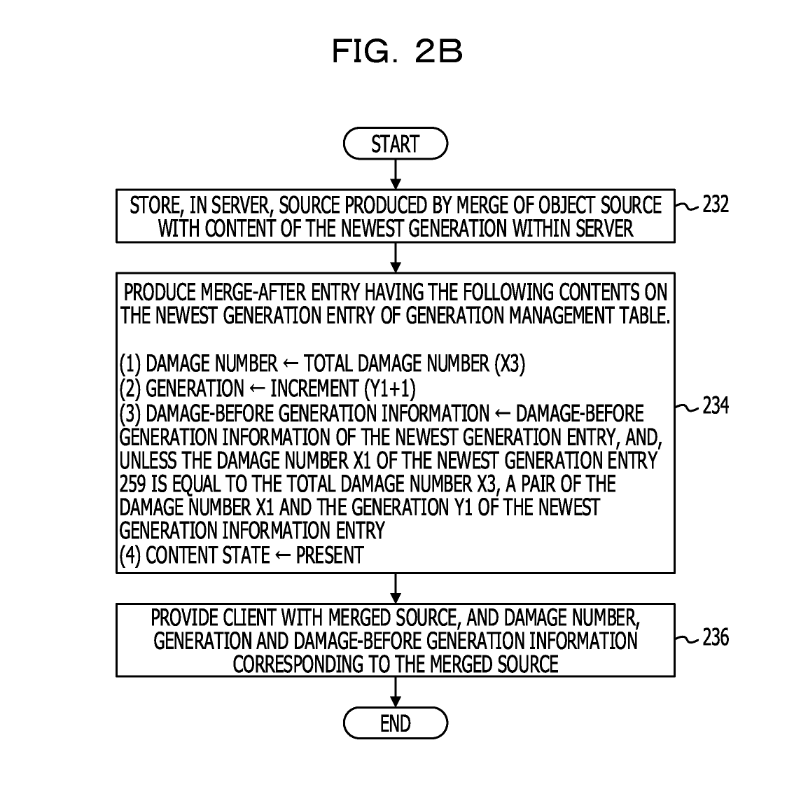

FIGS. 2A and 2B illustrate a process of merging and storing the sources maintained at a client in a server after the server is damaged according to an embodiment.

FIG. 2A illustrates an object source property maintained at the client and the update content of a generation management table maintained at the server when a new source is found in the client (hereinafter, the found source is called an “object source.”) In the object source property 210 maintained at the client, X2 is stored as an object source damage number 212, Y2 is stored as the generation 214, (Xa:Yb) is stored as generation information before damage 216, and “not-updated” or “update ended” is stored as the content sate 218. As used herein, the term “not-updated” refers to a source maintained at the client which is not updated, and the term “update ended” refers to a source maintained at the client which has been updated.

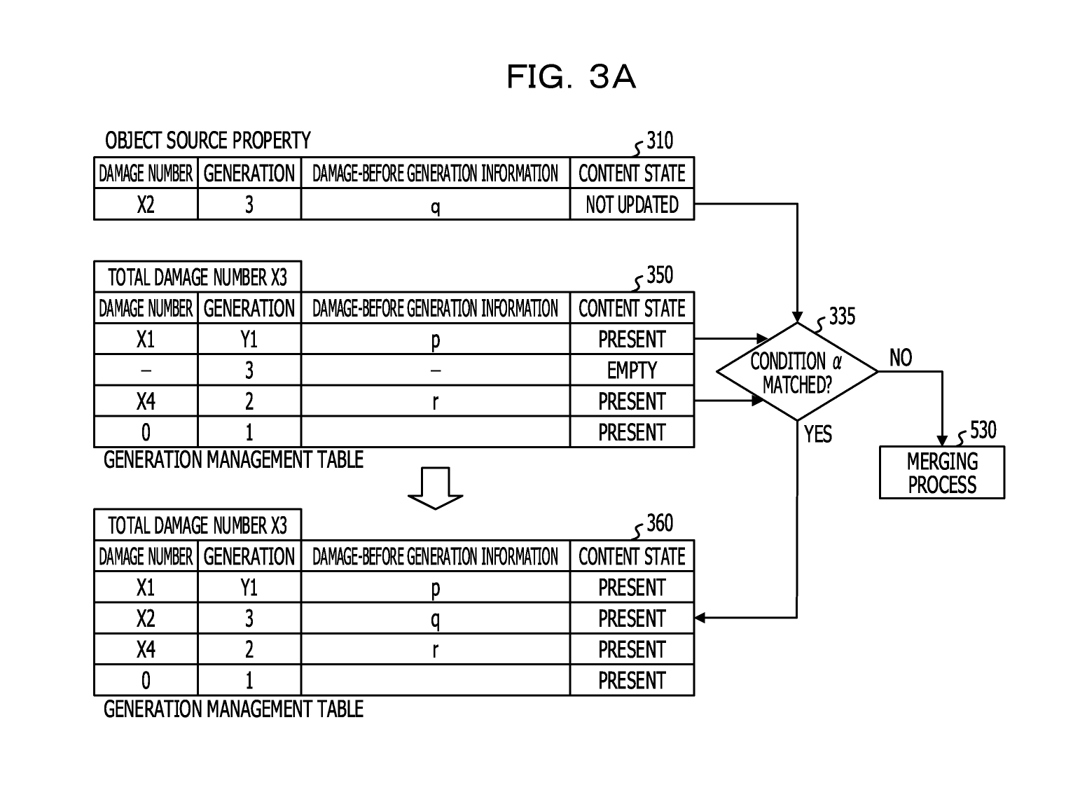

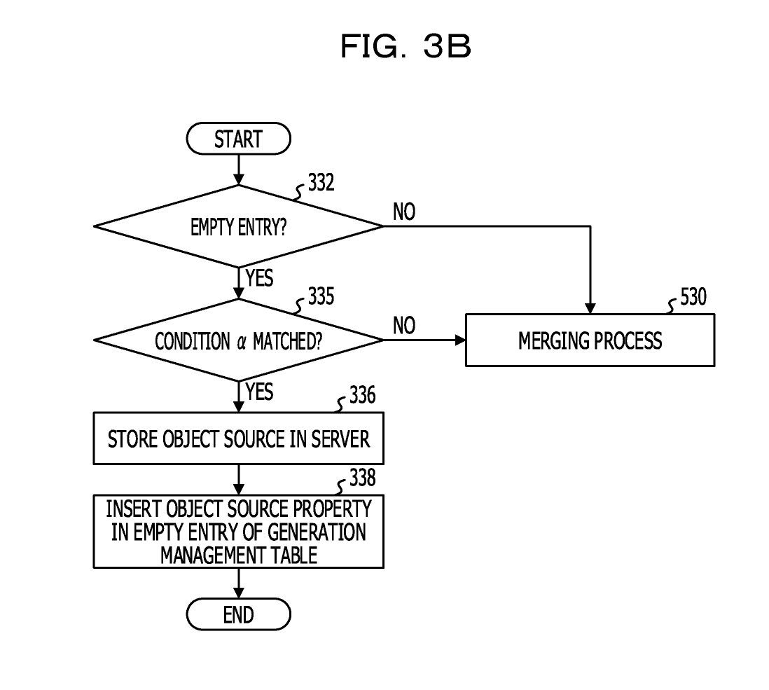

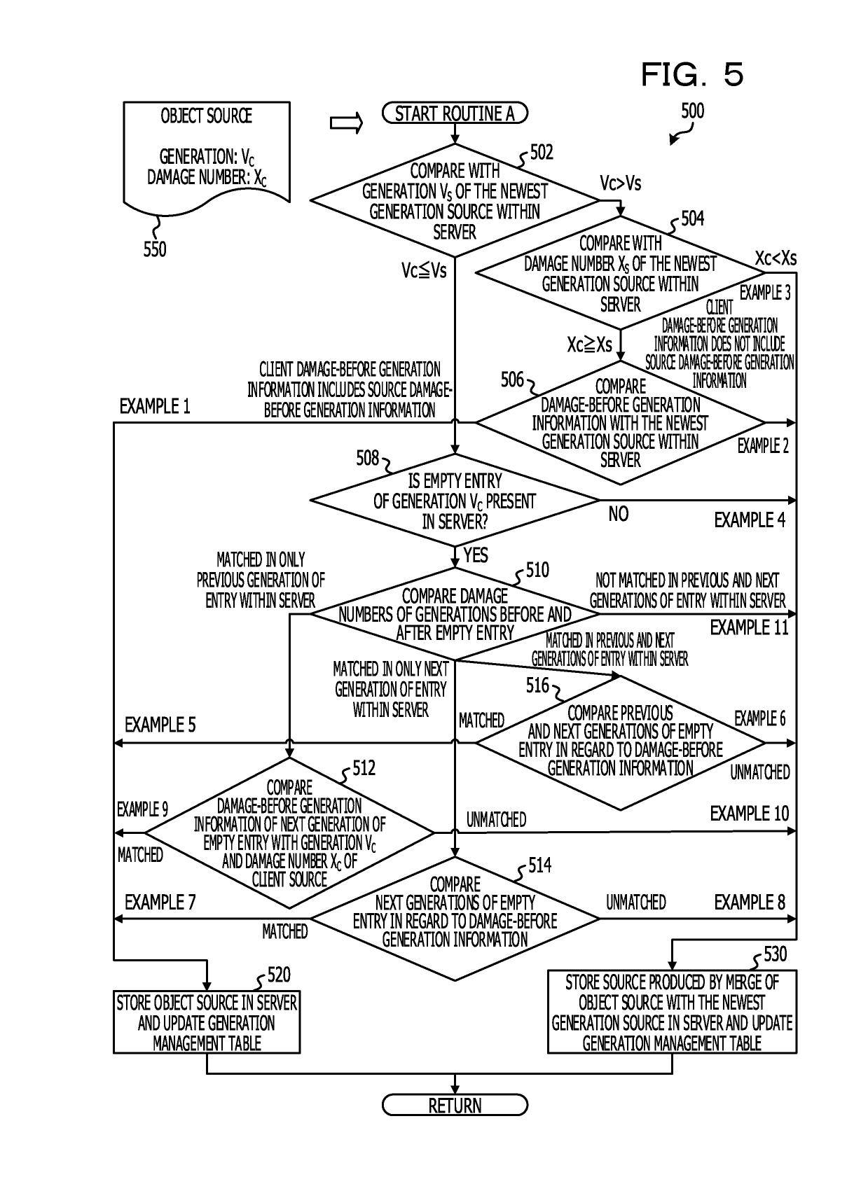

Since “empty” is present as the content state in a generation management table 250, if an object source corresponds to an entry of “empty,” the information of an object source property may be intactly stored in the entry of “empty” and the object source may be stored in the server, an example of which will be described later with reference to FIGS. 3A and 3B. Since it can be seen in FIG. 2A that an object source has no correspondence to the entry of “empty” of the generation management table, a case where a new entry is produced in the generation management table will be described below. In addition, the method of checking the disability to store an object source in the entry of “empty” of the generation management table will be described later with reference to FIG. 5.

As illustrated in the generation management table 250 of FIG. 2A, some entries of “present” exist in the content state. This indicates that the server has already collected and stored some sources from the client and stored information on these sources in the generation management table. Under this state, a case where a new object source having a property 210 is found in the client is envisaged. This object source is merged with the source corresponding to the newest generation entry 259 and is stored in the server. Then, an entry after merging 269 is produced and stored in an entry management table 260. The newest generation entry 259 has X1 as a damage number 252, Y1 as the generation 254, (X0:Y0) as the generation information before damage 256, and “present” as the content state. In this case, the object source is merged with the source corresponding to the newest generation entry 259 and a source after merging is stored in the server. Then, the entry after merging 269 is newly produced as an entry corresponding to the source after merging. As the content of the entry after merging 269, the content X3 of the total damage number 252 is stored as a damage number 262. Y1+1, which corresponds to an incremental value of the previous generation Y1 of the newest generation entry 259, is stored as the generation 264. Since X1 is different from X3 in comparison of the damage number X1 of the newest generation entry 268 with the total damage number 251, a pair of the damage number X1 and the generation Y1 of the newest generation entry 259 is added to (X0:Y0), and (X0:Y0, X1:Y1) is stored as the generation information before damage 266. If X1 equals to X3, only (X0:Y0) is stored as the generation information before damage of the entry after merge 269 (not shown). “Present” is stored as the content state 268.

FIG. 2B is a flow chart of the above process of FIG. 2A.

At step 232, the source content of the newest generation within the server, including a source merged with an object source, is stored in the server.

At step 234, “entry after merge” having the following contents is produced on the “newest generation entry” of the generation management table.

(1) Damage number<-total damage number (X3)

(2) Generation<-Increment (Y1+1)

(3) Generation information before damage<-generation information before damage of the newest generation entry, and, unless the damage number X1 of the newest generation entry 259 equals to the total damage number X3, a pair of the damage number X1 and the generation Y1 of the newest generation information entry.

(4) Content state<-“present”

At step 236, the client may be provided with the merged source, and damage number, generation and generation information before damage corresponding to the merged source. In addition, the content state of the property of the client may be set to be “not-updated.” By virtue of this step, the same management information is maintained for the same source in the client and the server.

FIGS. 3A and 3B are views illustrating a process of intactly storing a source maintained at the client in the server after the server is damaged according to one embodiment.

As illustrated in a generation management table 350 of FIG. 3A, some entries of “present” exist in the content state. This indicates that the server has already collected and stored some sources from the client and stored information on these sources in the generation management table.

FIG. 3A illustrates an object source property 310. In this example, it is assumed that an object source is not updated in the client. It is checked in a conditional decision block 335 whether or not the object source property 310 and entries before and after the entry having the content state “empty” of the generation management table 350 existing in the server satisfy a condition α. If the condition α is satisfied, the object source property can be inserted in the entry having the content state “empty,” as illustrated in a generation management table 360. Then, the object source is stored in the server. Details of the condition α will be described later with reference to FIG. 5 (the condition α indicates a condition derived at step 520, for example, in FIG. 5, but the present disclosure is not limited thereto). If the condition α is not satisfied, a merging process 530 is performed, for example, as illustrated in FIG. 3A.

FIG. 3B is a flow chart of the process of FIG. 3A.

At step 332, it is determined whether or not an empty entry of the same generation as the generation maintained at the object source is present in the generation management table managed by the server. If it is determined that an empty entry of the same generation is not present (“NO”), the merging process 530 is performed. If it is determined that an empty entry of the same generation is present (“YES,”), the process proceeds to Step 335.

At step 335, it is determined whether or not the object source property 310 and the entries before and after the entry having the content state “empty” of the generation management table 350 existing in the server satisfy the condition α. If the determination is “NO”, the merging process 530 is performed. If the determination is “YES,” the process proceeds to Step 336.

At step 336, the object source is intactly stored in the server.

At step 338, the object source property 310 is inserted in the empty entry of the generation management table 360.

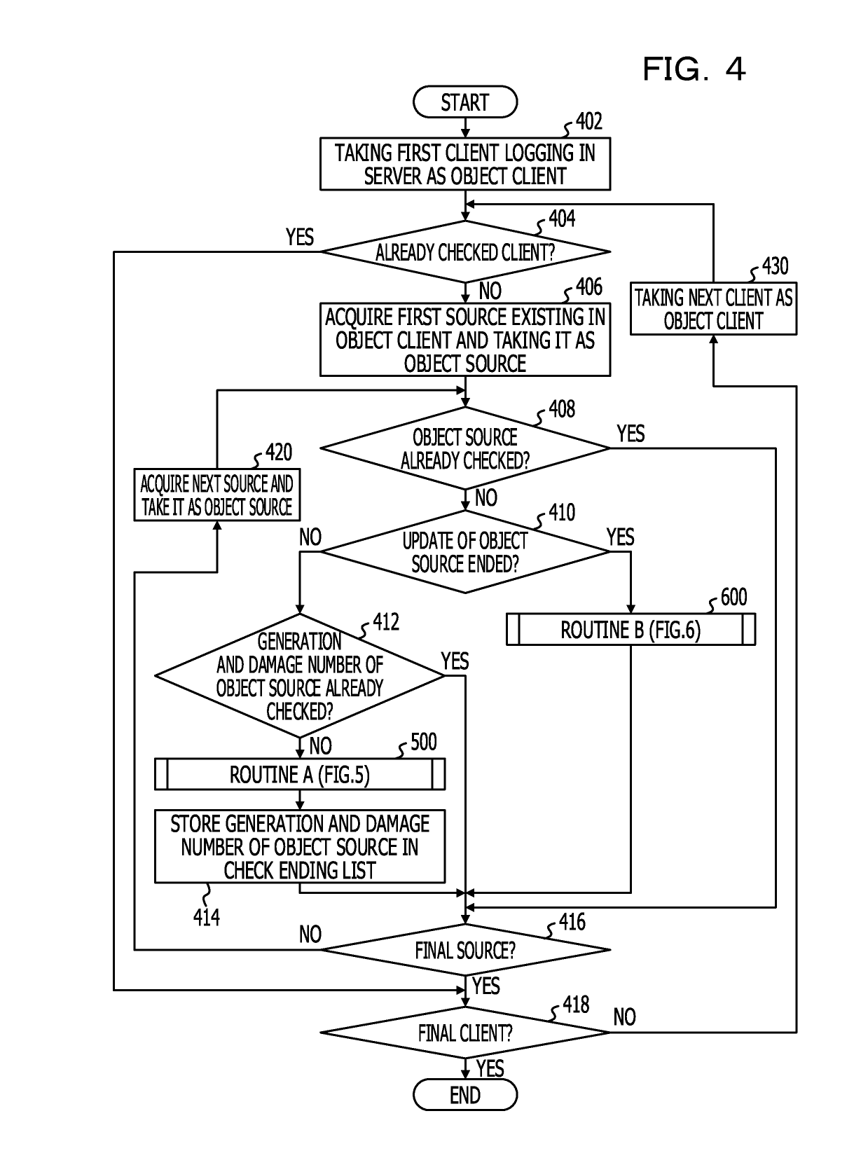

FIG. 4 is a schematic flow chart of a process of restoring a server using a source remaining in a client. This process is an exemplary embodiment and the present disclosure is not limited thereto.

At step 402, a first client logging in the server is taken as an object client. At this step, a target client among the clients logging in the server is specified. The clients may be processed in a log-in order.

At Step 404, it is checked whether or not an already checked client is present. There is no need to check an already checked client again. Therefore, the server may store information to identify the checked client for this process. If the checking result is “YES”, the process proceeds to step 418.

At step 418, it is checked whether or not the client is a final client. If the checking result is “YES”, the process is ended. If, however, the checking result is “NO”, the process proceeds to step 430

At step 430, the next client is taken as an object client. And the process returns to step 404.

In the series of steps described above, each of non-processed clients among the clients logging in the server is selected and processed. If the determination at step 404 is “NO”, the process proceeds to step 406.

At step 406, a first source existing in the object client is acquired and taken as an object source. A candidate source to be processed is first specified through this step.

At step 408, it is determined whether or not the object source has been already checked. For the purpose of carrying out this step, the server may store the already checked source for each client. If the determination result is “YES”, the process proceeds to Step 416

At step 416, it is determined whether or not the object source is a final source. If the determination result is “YES”, the process proceeds to step 418. If, however the determination result is “NO”, the process proceeds to step 420.

At step 420, the next source is acquired and taken as an object source. Then, the process returns to step 408.

In the series of steps described above, the sources maintained at the object client are exhaustively processed. If the determination result is “NO” at step 408, the process proceeds to step 410.

At step 410, it is determined whether or not the object source has been updated in the client. If the determination result is “YES”, the process proceeds to a routine B 600.”

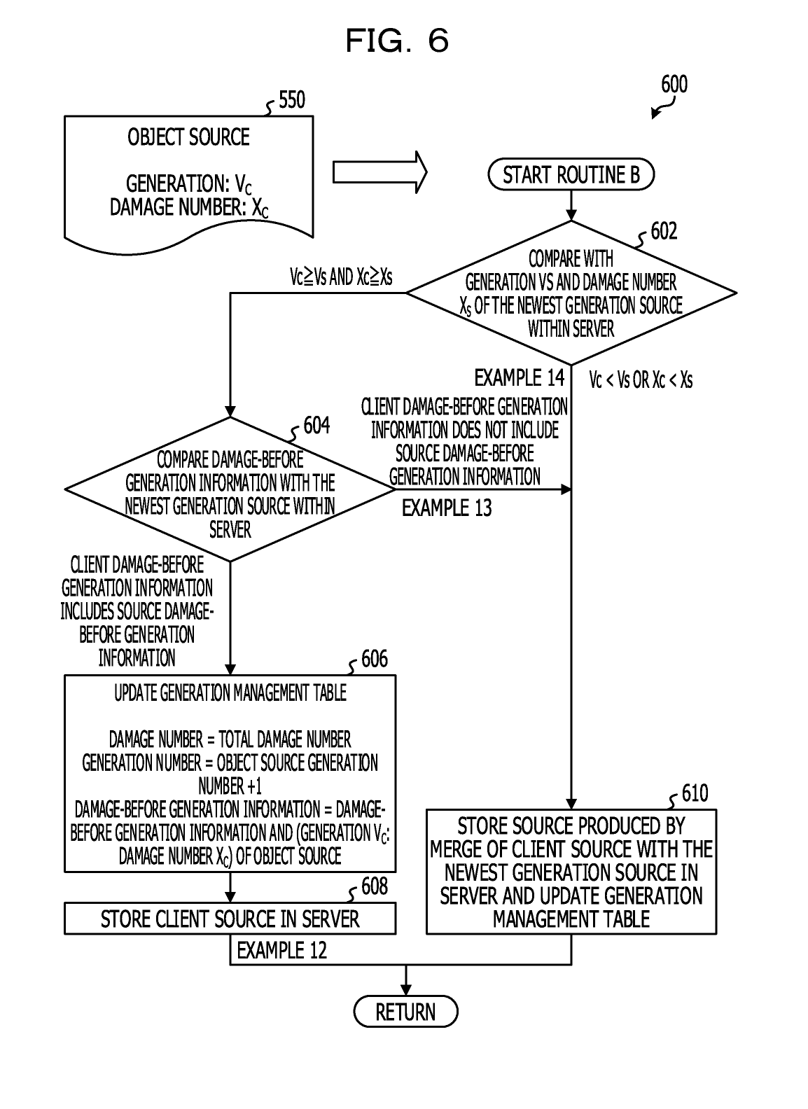

The routine B 600 will be described in detail with reference to FIG. 6. If the determination result is “NO” at step 410, the process proceeds to step 412.

At step 412, it is determined whether or not the generation and damage number of the object source have already been checked. If the determination result is “YES”, the process may bypass to step 416. The reason for the bypass is that, if an object source having the same generation and the same damage number has been already checked, information on the object source has been already reflected in the server and has no need to be checked again. If the determination result is “NO” at step 412, the process proceeds to a routine A 500 which will be described in detail with reference to FIG. 5. Thereafter, the process proceeds to step 414. At step 414, the generation and the damage number of the object source are stored in a check ending list. This list may be used for the determination at step 412.

In the series of steps described above, all sources existing in all clients logging in the server are checked

The above-described process is an example for checking all the sources for all the clients exhaustively. Various algorithms for exhaustive checking are apparent to those skilled in the art and the present disclosure is not limited to these embodiments.

FIG. 5 is a flow chart 500 illustrating the details of a process in the server in a case where an object source possessed by a client is not updated.

This flow chart assumes a case where an object source 550 having the generation Vc and the damage number Xc is input. Examples 1 to 11 illustrated in FIG. 5 correspond to the following Examples 1 to 11 described in the specification, respectively.

At step 502, the object source generation Vc is compared with the generation Vs of the newest generation source in the server. If Vc≦Vs, the process proceeds to step 508. If Vc>Vs, the process proceeds to step 504.

At step 504, the object source damage number Xc is compared with the damage number Xs of the newest generation source in the server. If Xc≧Xs, the process proceeds to step 506. If Xc<Xs, the process proceeds to step 530. An example for this case is illustrated in Example 3 below.

At step 506, with respect to the generation information before damage, the object source is compared with the newest generation source in the server. If the generation information before damage of the client does not include the generation information before damage of the source, the process proceeds to step 530. An example for this case is illustrated in Example 2.

At step 506, if the generation information before damage of the client includes the generation information before damage of the source, the process proceeds to step 520. An example for this case is illustrated in Example 1.

At step 508, it is checked whether or not an empty entry of the generation Vc of the client object source is present in the generation management table of the server. If the checking result is “NO”, the process proceeds to step 530. An example for this case is illustrated in Example 4.

If the determination result is “YES” at step 508, the process proceeds to step 510.

At step 510, the damage number of the client object source is compared with the damage numbers of the generation before and after the empty entry of the generation management table. In addition, if an entry of the generation immediately before or after the empty entry of the generation management table is an empty entry, it may be compared with the content of a recent entry not emptied in the generation management table. If all entries before the empty entry are empty, the determination on the previous entry at step 510 may be considered to be satisfied for further process. Similarly, if all entries after the empty entry are empty, the determination on the next entry at step 510 may be considered to be satisfied for further process.

If it is determined at step 510 that the damage number of the client object source equals to the damage number of the generation before the empty entry in the server, the process proceeds to step 512.

If it is determined at step 510 that the damage number of the client object source equals to the damage number of the generation after the empty entry in the server, the process proceeds to step 514.

If it is determined at step 510 that the damage number of the client object source equals to both of the damage numbers of the generation before and after the empty entry in the server, the process proceeds to step 516.

If it is determined at step 510 that the damage number of the client object source equals to none of the damage numbers of the generation before and after the empty entry in the server, the process proceeds to step 530. An example for this case is illustrated in Example 11.

At step 512, the generation information before damage of the next generation of the empty entry of the generation management table is compared with the generation Vc and the damage number Xc of the client object source. If the comparison coincides, the process proceeds to step 520. An example for this case is illustrated in Example 9.

If the comparison result does not coincide at step 512, the process proceeds to step 530. An example for this case is illustrated in Example 10.

At step 514, with respect to the generation information before damage, the client object source is compared with the next generation of the empty entry. If the comparison result coincides, the process proceeds to step 520. An example for this case is illustrated in Example 7.

If the comparison result does not coincide at step 514, the process proceeds to step 530. An example for this case is illustrated in Example 8.

At step 516, with respect to the generation information before damage, the client object source is compared with the previous and next generations of the empty entry. If the comparison result coincides, the process proceeds to step 520. An example for this case is illustrated in Example 5.

If the comparison result does not coincide at step 516, the process proceeds to step 530. An example for this case is illustrated in Example 6.

At step 520, the object source is intactly registered in the server, as described above. In addition, the generation management table is updated as described above (FIGS. 3A and 3B).

At step 530, the object source is merged with the source of the newest generation of the server and is stored in the server. In addition, the generation management table is updated as described above (FIGS. 2A and 2B).

FIG. 6 is a flow chart 600 illustrating the details of a process in the server in a case where an object possessed by a client is updated. This flow chart 600 also assumes a case where an object source 550 is input.

At step 602, the object source generation Vc and the damage number Xc of the client are compared with the generation Vs and the damage number Xs of the newest generation source in the server. If Vc≧Vs and Xc≧Xs, the process proceeds to step 604. If Vc<Vs or Xc<Xs, the process proceeds to step 610. An example for this case is illustrated in Example 14.

At step 604, with respect to the generation information before damage, the client object source is compared with the newest generation source in the server. If the generation information before damage of the client does not include the generation information before damage of the source, the process proceeds to step 610. An example for this case is illustrated in Example 13.

At step 604, if the generation information before damage of the client includes the generation information before damage of the source, the process proceeds to step 606.

At step 606, the generation management table is updated as below.

Damage number=Total damage number

Generation Number=object source generation number+1

Generation information before damage=generation information before damage and (generation Vc:damage number Xc) of the object source

Then, after step 606, the process proceeds to step 608. An example for this case is illustrated in Example 12.

At step 608, the client object source may be intactly stored in the server.

At step 610, the client source is merged with the source of the newest generation of the server and the merged source is stored in the server, and then the generation management table is updated.

### Example 1

As illustrated in Table 1, a client object source may be determined to be a file corresponding to the next generation of a file registered in the server. Accordingly, the client object source may be intactly stored in the server. In addition, the generation 3 of the generation management table of the server may be in an empty state. In addition, in Table 1, although no entry is present in the generation information before damage, the content of the generation information before damage may be “empty” if an entry having the damage number of 0 corresponds to the generation before damage.

TABLE 1

| | | | |
|---|---|---|---|
| Damage | | Generation information | Content |
| number | Generation | before damage | state |

Client object source property

| | | |
|---|---|---|
| 0 | 4 | Not |
| | | updated |

Generation management table total
damage number 1 (before modification)

| | | |
|---|---|---|
| 0 | 2 | present |
| 0 | 1 | present |

Generation management table total
damage number 1 (after modification)

| | | | |
|---|---|---|---|
| 0 | 4 | | present |
| — | 3 | — | empty |
| 0 | 2 | | present |
| 0 | 1 | | present |

### Example 2

As illustrated in Table 2, the generation information before damage of the client object source is (0:2) and is different from (i.e., does not include) the generation information before damage (0:1) of the newest generation of the generation management table. Accordingly, the client object source is not a next generation file created by the update of the source of the newest generation of the server. As a result, the object source may not be intactly registered in the server. Accordingly, the source produced by the merge of the object source with a source of the generation 2 of the server may be registered as the generation 3.

TABLE 2

| | | | |
|---|---|---|---|
| Damage | | Generation information | Content |
| number | Generation | before damage | state |

Client object source property

| | | | |
|---|---|---|---|
| 1 | 3 | (0:2) | Not |
| | | | updated |

Generation management table total
damage number 2 (before modification)

| | | | |
|---|---|---|---|
| 1 | 2 | (0:1) | present |
| 0 | 1 | | present |

Generation management table total
damage number 2 (after modification)

| | | | |
|---|---|---|---|
| 2 | 3 | (0:1, 1:2) | present |
| 1 | 2 | (0:1) | present |
| 0 | 1 | | present |

### Example 3

As illustrated in Table 3, although the client object source is the generation 3, it is a file which does not reflect the content of the generation 2 registered in the server since the damage number of the generation 2 registered in the server is large. Therefore, the client object source may not be intactly registered in the server. This is because the content of the generation 2 is not reflected in the content of the generation 3. Accordingly, a source produced by the merge of the object source with a source of the generation 2 of the server may be stored as the generation 3 in the server.

TABLE 3

| | | | |
|---|---|---|---|
| Damage | | Generation information | Content |
| number | Generation | before damage | state |

Client object source property

| | | |
|---|---|---|
| 0 | 3 | Not |
| | | updated |

Generation management table total
damage number 2 (before modification)

| | | | |
|---|---|---|---|
| 1 | 2 | (0:1) | present |
| 0 | 1 | | present |

Generation management table total
damage number 2 (after modification)

| | | | |
|---|---|---|---|
| 2 | 3 | (0:1, 1:2) | present |
| 1 | 2 | (0:1) | present |
| 0 | 1 | | present |

### Example 4

Although the client object source is the generation 2, it cannot be registered in the server since a file of the damage number 1 was already registered in the generation 2. Accordingly, a source produced by the merge of the client object source with a source of the newest generation (generation 3) of the server may be stored as the generation 4 in the server.

TABLE 4

| | | | |
|---|---|---|---|
| Damage | | Generation information | Content |
| number | Generation | before damage | state |

Client object source property

| | | |
|---|---|---|
| 0 | 2 | Not |
| | | updated |

Generation management table total
damage number 2 (before modification)

| | | | |
|---|---|---|---|
| 1 | 3 | (0:1) | present |
| 1 | 2 | (0:1) | present |
| 0 | 1 | | present |

Generation management table total
damage number 2 (after modification)

| | | | |
|---|---|---|---|
| 2 | 4 | (0:1, 1:3) | present |
| 1 | 3 | (0:1) | present |
| 1 | 2 | (0:1) | present |
| 0 | 1 | | present |

### Example 5

The client object source has the same generation information before damage as the previous and next generations (generations 2 and 4) registered in the server. This can cause no contradiction and may allow the client object source to be intactly stored in the server.

TABLE 5

| | | | |
|---|---|---|---|
| Damage | | Generation information | Content |
| number | Generation | before damage | state |

Client object source property

| | | | |
|---|---|---|---|
| 1 | 3 | (0:1) | Not |
| | | | updated |

Generation management table total
damage number 2 (before modification)

| | | | |
|---|---|---|---|
| 1 | 4 | (0:1) | present |
| — | 3 | — | empty |
| 1 | 2 | (0:1) | present |
| 0 | 1 | | present |

Generation management table total
damage number 2 (after modification)

| | | | |
|---|---|---|---|
| 1 | 4 | (0:1) | present |
| 1 | 3 | (0:1) | present |
| 1 | 2 | (0:1) | present |
| 0 | 1 | | present |

### Example 6

The generation information before damage of the client object source equals to none of the generation information before damage of the generations 2 and 4 registered in the server. It may be therefore determined that the object source is a file which does not reflect the content of the generation 2 registered in the server and, in addition, the content of the generation 4 of the server does not reflect the object source. This disallows the object source to be intactly registered in the server. Accordingly, a source produced by the merge of the object source with a source of the newest generation of the server may be stored as the generation 5 in the server.

TABLE 6

| | | | |
|---|---|---|---|
| Damage | | Generation information | Content |
| number | Generation | before damage | state |

Client object source property

| | | | |
|---|---|---|---|
| 1 | 3 | (0:2) | Not |
| | | | updated |

Generation management table total
damage number 2 (before modification)

| | | | |
|---|---|---|---|
| 1 | 4 | (0:1) | present |
| — | 3 | — | empty |
| 1 | 2 | (0:1) | present |
| 0 | 1 | | present |

Generation management table total
damage number 2 (after modification)

| | | | |
|---|---|---|---|
| 2 | 5 | (0:1, 1:4) | present |
| 1 | 4 | (0:1) | present |
| — | 3 | — | empty |
| 1 | 2 | (0:1) | present |
| 0 | 1 | | present |

### Example 7

The damage number and the generation information before damage of the client object source equals to the damage number and the generation information before damage of the next generation (generation 4) registered in the server. It may be therefore determined that the original client object source has been in the currently emptied generation 3. This may allow the client object source to be intactly registered in the server.

TABLE 7

| | | | |
|---|---|---|---|
| Damage | | Generation information | Content |
| number | Generation | before damage | state |

Client object source property

| | | | |
|---|---|---|---|
| 1 | 3 | (0:2) | Not |
| | | | updated |

Generation management table total
damage number 2 (before modification)

| | | | |
|---|---|---|---|
| 1 | 4 | (0:2) | present |
| — | 3 | — | empty |
| 0 | 2 | | present |
| 0 | 1 | | present |

Generation management table total
damage number 2 (after modification)

| | | | |
|---|---|---|---|
| 1 | 4 | (0:2) | present |
| 1 | 3 | (0:2) | present |
| 0 | 2 | | present |
| 0 | 1 | | present |

### Example 8

The generation information before damage of the client object source is different from the generation information before damage of the next generation (the generation 4) registered in the server. It may be therefore determined that the generation 4 is not the one created by editing the client object source. Accordingly, an intact registration of the client object source in the server causes a contradiction. Accordingly, a source produced by the merge of the object source with a source of the newest generation of the server may be stored as the generation 5 in the server.

TABLE 8

| | | | |
|---|---|---|---|
| Damage | | Generation information | Content |
| number | Generation | before damage | state |

Client object source property

| | | | |
|---|---|---|---|
| 1 | 3 | (0:1) | Not |
| | | | updated |

Generation management table total
damage number 2 (before modification)

| | | | |
|---|---|---|---|
| 1 | 4 | (0:2) | present |
| — | 3 | — | empty |
| 0 | 2 | | present |
| 0 | 1 | | present |

Generation management table total
damage number 2 (after modification)

| | | | |
|---|---|---|---|
| 2 | 5 | (0:2, 1:4) | present |
| 1 | 4 | (0:2) | present |
| — | 3 | — | empty |
| 0 | 2 | | present |
| 0 | 1 | | present |

### Example 9

The damage number and the generation of the client object source matches the generation information before damage of the next generation (the generation 4) registered in the server. It may be therefore determined that the source of the generation 4 stored in the server is the one created by editing the client object source. Accordingly, the object source may be intactly registered in an “empty” entry of the server. In addition, the client object source property may be stored in an empty entry of the generation management table of the server.

TABLE 9

| | | | |
|---|---|---|---|
| Damage | | Generation information | Content |
| number | Generation | before damage | state |

Client object source property

| | | |
|---|---|---|
| 0 | 3 | Not |
| | | updated |

Generation management table total
damage number 2 (before modification)

| | | | |
|---|---|---|---|
| 1 | 4 | (0:3) | present |
| — | 3 | — | empty |
| 0 | 2 | | present |
| 0 | 1 | | present |

Generation management table total
damage number 2 (after modification)

| | | | |
|---|---|---|---|
| 1 | 4 | (0:3) | present |
| 0 | 3 | | present |
| 0 | 2 | | present |
| 0 | 1 | | present |

### Example 10

The damage number and the generation of the client object source does not match the generation information before damage of the next generation (the generation 4) registered in the server. Data (damage number:1, generation:3, and generation information before damage: (0:2)) should be originally registered in the generation 3 of the generation management table. Accordingly, an intact registration of the object source in the server causes a contradiction. Accordingly, a source produced by merge of the object source with a source of the newest generation of the server may be stored as the generation 5 in the server.

TABLE 10

| | | | |
|---|---|---|---|
| Damage | | Generation information | Content |
| number | Generation | before damage | state |

Client object source property

| | | |
|---|---|---|
| 0 | 3 | Not |
| | | updated |

Generation management table total
damage number 2 (before modification)

| | | | |
|---|---|---|---|
| 1 | 4 | (0:2) | present |
| — | 3 | — | empty |
| 0 | 2 | | present |
| 0 | 1 | | present |

Generation management table total
damage number 2 (after modification)

| | | | |
|---|---|---|---|
| 2 | 5 | (0:2, 1:4) | present |
| 1 | 4 | (0:2) | present |
| — | 3 | — | empty |
| 0 | 2 | | present |
| 0 | 1 | | present |

### Example 11

The damage number and the generation of the client object source does not match the damage numbers of the previous and next generations (the generations 2 and 4) of an empty entry registered in the server. An entry (damage number:0, generation: 3, and generation information before damage:empty) should be registered in the generation 3 of the generation management table. Accordingly, an intact registration of the client object source in the server causes a contradiction. Accordingly, a source produced by merge of the client object source with a source of the newest generation of the server may be stored as the generation 5 in the server.

TABLE 11

| | | | |
|---|---|---|---|
| Damage | | Generation information | Content |
| number | Generation | before damage | state |

Client object source property

| | | | |
|---|---|---|---|
| 1 | 3 | (0:2) | Not |
| | | | updated |

Generation management table total
damage number 2 (before modification)

| | | | |
|---|---|---|---|
| 0 | 4 | | present |
| — | 3 | — | empty |
| 0 | 2 | | present |
| 0 | 1 | | present |

Generation management table total
damage number 2 (after modification)

| | | | |
|---|---|---|---|
| 2 | 5 | (0:4) | present |
| 0 | 4 | | present |
| — | 3 | — | empty |
| 0 | 2 | | present |
| 0 | 1 | | present |

### Example 12

In this example, the client object source need not be merged since it is created by editing the newest generation source of the server. Since the client object source is updated in the client, when the client object source is stored in the server, the damage number and the generation information before damage are reflected in the server after being modified as follows.

Damage number=Total damage number

Generation Number=object source generation number+1

Generation information before damage=generation information before damage and (generation Vc:damage number Xc) of the object source

TABLE 12

| | | | |
|---|---|---|---|
| Damage | | Generation information | Content |
| number | Generation | before damage | state |

Client object source property

| | | | |
|---|---|---|---|
| 1 | 4 | (0:2) | updated |

Generation management table total
damage number 2 (before modification)

| | | | |
|---|---|---|---|
| 1 | 4 | (0:2) | present |
| — | 3 | — | empty |
| 0 | 2 | | present |
| 0 | 1 | | present |

Generation management table total
damage number 2 (after modification)

| | | | |
|---|---|---|---|
| 2 | 5 | (0:2, 1:4) | present |
| 1 | 4 | (0:2) | present |
| — | 3 | — | empty |
| 0 | 2 | | present |
| 0 | 1 | | present |

### Example 13

Since the generation information before damage of the client object source is different from the generation information before damage of the newest generation source of the server, the client object source is not the one created by editing the newest generation source. Accordingly, the client object source cannot be intactly registered in the server. Accordingly, a source produced by merge of the client object source with a source of the newest generation of the server may be stored as the generation 5 in the server.

TABLE 13

| | | | |
|---|---|---|---|
| Damage | | Generation information | Content |
| number | Generation | before damage | state |

Client object source property

| | | | |
|---|---|---|---|
| 1 | 4 | (0:3) | updated |

Generation management table total
damage number 2 (before modification)

| | | | |
|---|---|---|---|
| 1 | 4 | (0:2) | present |
| — | 3 | — | empty |
| 0 | 2 | | present |
| 0 | 1 | | present |

Generation management table total
damage number 2 (after modification)

| | | | |
|---|---|---|---|
| 2 | 5 | (0:2, 1:4) | present |
| 1 | 4 | (0:2) | present |
| — | 3 | — | empty |
| 0 | 2 | | present |
| 0 | 1 | | present |

### Example 14

The newest generation of the server is larger than the client object source. Therefore, if the client object source is intactly stored in the server, the update of the newest generation source of the server is destroyed. Accordingly, a source produced by merge of the client object source with the newest generation source of the server may be stored as the generation 5 in the server.

TABLE 14

| | | | |
|---|---|---|---|
| Damage | | Generation information | Content |
| number | Generation | before damage | state |

Client object source property

| | | | |
|---|---|---|---|
| 1 | 3 | (0:2) | updated |

Generation management table total
damage number 2 (before modification)

| | | | |
|---|---|---|---|
| 1 | 4 | (0:2) | present |
| — | 3 | — | empty |
| 0 | 2 | | present |
| 0 | 1 | | present |

Generation management table total
damage number 2 (after modification)

| | | | |
|---|---|---|---|
| 2 | 5 | (0:2, 1:4) | present |
| 1 | 4 | (0:2) | present |
| — | 3 | — | empty |
| 0 | 2 | | present |
| 0 | 1 | | present |

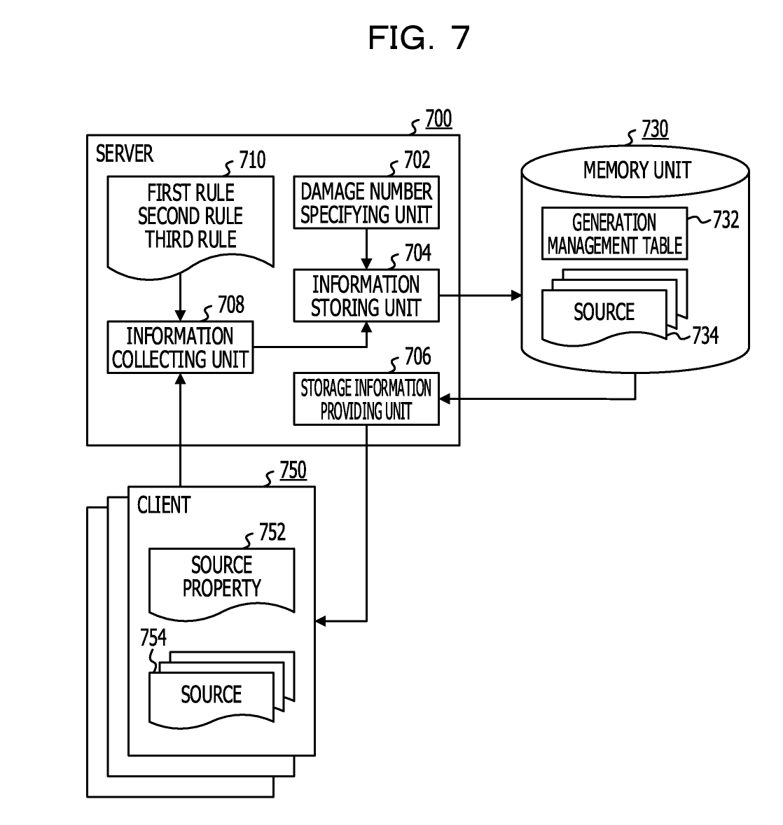

FIG. 7 is a functional block diagram of an embodiment.

A server 700 includes a damage number specifying unit 702, an information storing unit 704, a storage information providing unit 706 and an information collecting unit 708, and uses at least first, second and third rules 710. The server 700 uses a memory unit 730 storing at least a generation management table 732 and a plurality of sources 734. The memory unit may be a part of the server.

In addition, one or more clients 750 exist and at least a source 754 and a property 752 related to the source are stored in the client 750.

The damage number specifying unit 702 specifies the number of damages of the server from the past to the present. When a source is stored in the server, the information storing unit 704 stores the damage number, the generation and the generation information before damage in the server in association with the source.

The storage information providing unit 706 provides the source and the damage number, the generation and the generation information before damage corresponding to the source to the client.

When the server is restored from any damage, the information collecting unit 708 collects the source existing in the client based on a result where the first rule 710 is applied to the information including the generation, the damage number and the generation information before damage corresponding to the source existing in the client.

The first rule may include decision rules of step 410 in FIG. 4 and the steps in FIGS. 5 and 6.

The second rule may include decision rules of steps 510, 512, 514 and 516 in FIG. 5.

The third rule may include decision rules of steps 602 and 614 in FIG. 6.

The above first, second and third rules are not limited to the above-exemplified decision rules.

The server uses the generation management table 732 to manage the sources 734. The client(s) uses the source property 752 to manage the source 754.

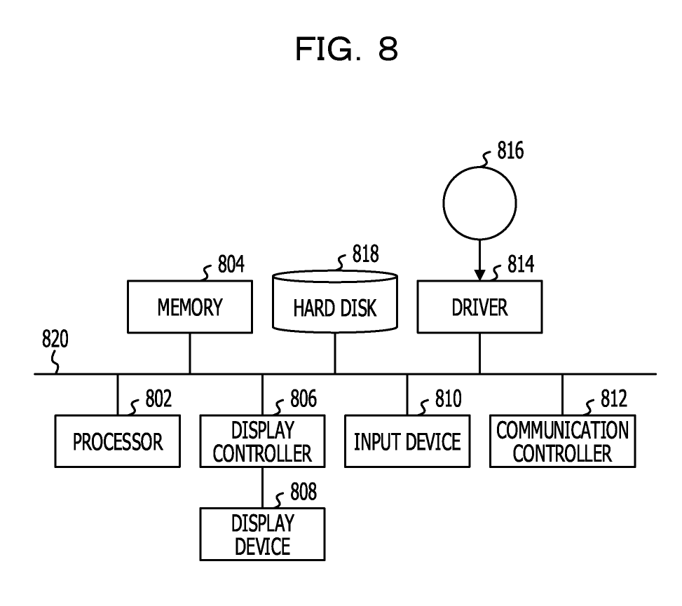

FIG. 8 is a view showing an example of hardware configuration according to an embodiment. The hardware configuration includes a processor 802, a memory 804, a display controller 806, a display device 808, an input/output device 810, a communication controller 812, a driver 814 and a hard disk 818, which are coupled via a bus 820. The driver 814 can write/read data into/from a portable recording medium 816. A network (not shown) may be coupled to the communication controller 812. The hardware configuration may be employed for both the client and the server. Management information such as the sources, the generations related to the sources may be stored in the hard disk 818 and/or the memory 804.

Some or all of programs in an embodiment may be stored, for example, in the memory 804 and the hard disk 818 and may be operated by the processor 802.

These embodiments may be entirely or partially implemented by a program which may be stored in the portable recording medium 816. As used herein, the portable recording medium 816 refers to one or more non-transitory tangible storage media having any structure. Examples of the portable recording medium 816 may include a magnetic recording medium such as, for example, a hard disk drive (HDD), a flexible disk (FD), or a magnetic tape (MT), an optical disk such as, for example, a DVD (Digital Versatile Disc), DVD-RAM, CD-ROM (Compact Disc-Read Only Memory), or CD-R (Recordable)/RW (ReWritable), a magneto-optical recording medium such as, for example, a MO (Magneto-Optical disk), and a non-volatile memory. When the program stored in the portable recording medium is read and executed by the processor, the present embodiment can be entirely or partially carried out.

According to the embodiments described above, when a server is damaged, it is possible to build an environment in which the information resources of the server can readily be restored using the information resources remaining in a client.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention has (have) been described in detail, it should be understood that the various changes, substitutions, and alterations could be made hereto without departing from the spirit and scope of the invention.

What is claimed is:

1. A computer-readable storage medium storing a computer executable program that, when executed, causes a server to manage information resources and generations of the information resources managed by a client and causes the server to execute a process comprising:
specifying a current damage number of the server;
storing the current damage number, the generations and generation information before damage in the server in association with the information resources when the information resources are stored in the server; and
providing the client with the information resources, the damage number, the generations and the generation information before damage in association with the information resources,
wherein the damage number, the generations and the generation information before damage provided to the client are at least used to restore the server from any damage, and
wherein the generation information before damage includes the damage number and the generation of an original information resource which serves as the basis of update of the information resource, the damage number of the original information resource being smaller than the damage number of the information resources.

2. The computer-readable storage medium according to claim 1, wherein the process further comprising:
collecting the information resources existing in the client based on a result of application of a predetermined first rule to information including the damage number, the generations and the generation information before damage in association with the information resources existing in the client when the server is restored from any damage.

3. The computer-readable storage medium according to claim 2,
wherein, when a second information resource updated based on a first information resource is stored in the server, the generation information before damage is produced such that second generation information before damage corresponding to the second information resource includes first generation information before damage corresponding to the first information resource, and such that the generation information before damage of the second information resource further includes a pair of the damage number corresponding to the first information resource and the generation of the first information resource when the damage number corresponding to the first information resource is smaller than the current damage number.

4. The computer-readable storage medium according to claim 2,
wherein the predetermined first rule includes a rule to determine whether or not the information resources existing in the client have been updated and determine whether the information resources existing in the client are stored in the server intactly or with merge with the information resources stored in the server, based on a result of comparison between the information resources existing in the client and the information resources stored in the server in regard to the damage number, the generation and the generation information before damage.

5. The computer-readable storage medium according to claim 2,
wherein the predetermined first rule includes a rule to determine that the information resources existing in the client are intactly stored in the server when:
the information resources existing in the client are not updated,
the generation of the information resource existing in the client has a damage number larger than the damage number of the information resource of the newest generation stored in the server,
the damage number of the information resources existing in the client equals to or larger than the damage number of the information resource of the newest generation stored in the server, and
the generation information before damage of the information resources existing in the client includes generation information before damage of the information resource of the newest generation stored in the server.

6. The computer-readable storage medium according to claim 2,
wherein the predetermined first rule includes a rule to determine that the information resources existing in the client are intactly stored in the server when:
the information resources existing in the client are not updated,
the generation of the information resource existing in the client has a damage number equal to or smaller than the damage number of the information resource of the newest generation stored in the server,
a particular generation of the information resource existing in the client does not exist in the server, and
the damage number and the generation information before damage of the information resources existing in the client satisfy a predetermined second rule.

7. The computer-readable storage medium according to claim 6,
wherein the predetermined second rule includes a rule to determine that the information resources existing in the client are intactly stored in the server if:
the damage number of the information resources existing in the client matches only the damage number of the generation previous to the particular generation of the server, and
the newest generation information before damage of the generation next to the particular generation of the server matches a pair of the damage number and the generation of the information resources existing in the client.

8. The computer-readable storage medium according to claim 6,
wherein the predetermined second rule includes a rule to determine that the information resources existing in the client are intactly stored in the server when:
the damage number of the information resources existing in the client matches only the damage number of the generation next to the particular generation of the server, and
the generation information before damage of the generation next to the particular generation of the server matches the generation information before damage of the information resources existing in the client.

9. The computer-readable storage medium according to claim 6,
wherein the predetermined second rule includes a rule to determine that the information resources existing in the client are intactly stored in the server when:
the damage number of the information resources existing in the client matches both of the damage numbers of the generations previous and next to the particular generation of the server, and
the generation information before damage of the generations previous and next to the particular generation of the server matches the generation information before damage of the information resources existing in the client.

10. The computer-readable storage medium according to claim 2,
wherein the storing the current damage number, the generations and generation information before damage in the server includes storing the information resources existing in the client in the server intactly when:
the information resources existing in the client are updated, and
the damage number and the generation information before damage of the information resources existing in the client satisfy a predetermined third rule.

11. A method for a server to manage information resources and generations of the information resources managed by a client, the method comprising:
specifying a current damage number of the server;
storing the current damage number, the generations and generation information before damage in the server in association with the information resources when the information resources are stored in the server; and
providing the client with the information resources, and the damage number, the generations and the generation information before damage in association with the information resources,
wherein the damage number, the generations and the generation information before damage provided to the client are at least used to restore the server from any damage, and
wherein the generation information before damage includes the damage number and the generation of an original information resource which serves as the basis of update of the information resource, the damage number of the original information resource being smaller than the damage number of the information resources.

12. The method according to claim 11, further comprising:
collecting the information resources existing in the client based on a result of application of a predetermined first rule to information including the damage number, the generations and the generation information before damage in association with the information resources existing in the client when the server is restored from any damage.

13. The method according to claim 12,
wherein, when a second information resource updated based on a first information resource is stored in the server, the generation information before damage is produced such that second generation information before damage corresponding to the second information resource includes first generation information before damage corresponding to the first information resource, and such that the generation information before damage of the second information resource further includes a pair of the damage number corresponding to the first information resource and the generation of the first information resource when the damage number corresponding to the first information resource is smaller than the current damage number.

14. The method according to claim 12,
wherein the predetermined first rule includes a rule to determine whether or not the information resources existing in the client have been updated and determine whether the information resources existing in the client are stored in the server intactly or with merge with the information resources stored in the server, based on a result of comparison between the information resources existing in the client and the information resources stored in the server in regard to the damage number, the generation and the generation information before damage.

15. The method according to claim 12,
wherein the predetermined first rule includes a rule to determine that the information resources existing in the client are intactly stored in the server when:
the information resources existing in the client are not updated,
the generation of the information resource existing in the client has a damage number larger than the damage number of the information resource of the newest generation stored in the server,
the damage number of the information resources existing in the client equals to or larger than the damage number of the information resource of the newest generation stored in the server, and
the generation information before damage of the information resources existing in the client includes generation information before damage of the information resource of the newest generation stored in the server.

16. The method according to claim 12,
wherein the predetermined first rule includes a rule to determine that the information resources existing in the client are intactly stored in the server when:
the information resources existing in the client are not updated,
the generation of the information resource existing in the client has a damage number equal to or smaller than the damage number of the information resource of the newest generation stored in the server,
a particular generation of the information resource existing in the client does not exist in the server, and
the damage number and the generation information before damage of the information resources existing in the client satisfy a predetermined second rule.

17. The method according to claim 16,
wherein the predetermined second rule includes a rule to determine that the information resources existing in the client are intactly stored in the server if:
the damage number of the information resources existing in the client matches only the damage number of the generation previous to the particular generation of the server, and
the newest generation information before damage of the generation next to the particular generation of the server matches a pair of the damage number and the generation of the information resources existing in the client.

18. The method according to claim 16,
wherein the predetermined second rule includes a rule to determine that the information resources existing in the client are intactly stored in the server when:
the damage number of the information resources existing in the client matches only the damage number of the generation next to the particular generation of the server, and
the generation information before damage of the generation next to the particular generation of the server matches the generation information before damage of the information resources existing in the client.

19. The method according to claim 12,
wherein the storing the current damage number, the generations and generation information before damage in the server includes storing the information resources existing in the client in the server intactly when:
the information resources existing in the client are updated, and
the damage number and the generation information before damage of the information resources existing in the client satisfy a predetermined third rule.

20. A server that manages information resources and generations of the information resources managed by a client, comprising:
a memory; and
a processor configured to the memory and configured to:
specify a current damage number of the server,
store the current damage number, the generations and generation information before damage in the server in association with the information resources when the information resources are stored in the server, and
provide the information resources, and the damage number, the generations and the generation information before damage in association with the information resources to the client,
wherein the damage number, the generations and the generation information before damage provided to the client are at least used to restore the server from any damage, and
wherein the generation information before damage includes the damage number and the generation of an original information resource which serves as the basis of update of the information resource, the damage number of the original information resource being smaller than the damage number of the information resources.
